(19) United States
(12) Patent Application Publication
(10) Pub. No.: US 2025/0205919 A1
(43) Pub. Date: Jun. 26, 2025

(54) DEVICE FOR CUTTING PLASTIC CONTAINERS

(71) Applicant: INDUSTRIAS TECNOLÓGICAS DE MECANIZACIÓN Y AUTOMATIZACIÓN, S.A., Sant Just Desvem (ES)

(72) Inventor: Manuel GONZÁLEZ, Sant Just Desvem (ES)

(21) Appl. No.: 18/982,896

(22) Filed: Dec. 16, 2024

(30) Foreign Application Priority Data
Dec. 22, 2023 (EP) 23383358.1

(51) Int. Cl. B26F 1/44; B26D 5/00; B26F 1/40

(52) U.S. Cl. CPC B26F 1/44; B26D 5/00; B26F 1/40

(57) ABSTRACT

A device for cutting plastic containers comprises a die (1), a punch holder (2), cutting blades (11, 21) arranged in the die and/or the punch holder, and ejector plates (3) performing a nominal stroke between an extended position (A) and a retracted position (B) equivalent to a predetermined allowable thickness of accumulated material in the cutting area. Each ejector plate (3) includes a protruding indicator extending away from the ejector plate (3) in an axial direction towards a rear of the punch holder (2) and the device further comprises a position sensor (4) configured to detect when the protruding indicator reaches a raised position (C) due to a specific accumulation of material in the cutting area. The sensor (4) is connected to a control unit (5) comprising a processor (51) and an audible alarm (52) which is activated by the sensor (4).

### CROSS-REFERENCE TO RELATED APPLICATIONS

This application claims priority to European Patent Application No. 23383358.1, filed Dec. 22, 2023, the entire disclosure of which is hereby incorporated by reference herein.

### TECHNICAL FIELD

The present invention relates to a device for cutting plastic containers, preferably applicable in the packaging of food products, such as yogurts, custards, caramel puddings, or the like.

### Prior State of the Art

In the manufacture of containers for the food industry, forming multi-pack containers is common by means of a plastic, single-layer, or multi-layer sheet. These multi-pack containers have several individual cavities or containers that are joined by joining bridges defined in the plastic sheet itself.

Once they are formed, filled, and closed, the multi-pack containers are subjected almost simultaneously to a cutting operation whereby one part of the shape of the multi-pack container is defined, and a precutting operation, wherein precut lines are defined which affect the joining bridges and which facilitate the subsequent tearing and separation of the different individual containers.

Utility model ES 1291175U discloses a device for pre-cutting containers, in particular containers made of multilayer materials, comprising a matrix plate and a punch-holder plate provided with upper cutting blades for the realization of a line of cut in the multilayer material of the containers positioned on the matrix plate, wherein the upper cutting blades are arranged to make an upper pre-cut line of upper layers of the multilayer material, and the matrix plate incorporates, in a position facing the upper cutting blades, lower cutting blades arranged to make a lower pre-cut line of the lower layers of the multilayer material.

EP 3722217B1 discloses a machine for manufacturing multipack containers that comprises: a lower die associated with a press with vertical movement; a punch holder and a pre-cutting device which comprises an upper pre-cutting blade associated with the punch holder and a lower pre-cutting blade associated with the lower die for defining on the joining bridges of the individual containers the upper pre-cut lines and lower pre-cut lines, suitable for in use manually breaking said bridges and separating the individual containers formed in PET or which incorporate at least one PET layer.

Specifically, document EP 3722217B1 mentions the changing trend with respect to the material used for manufacturing containers of this type, and the use of PET (polyethylene terephthalate) which is 100% recyclable and reusable.

Due to its composition, PET reacts differently when cutting the containers, in which tiny pieces of material come off.

With the materials used previously, such as polystyrene (PS), the actual accumulation of the material that comes off in the cutting area did not present a problem because said material broke up into small particles.

With PET material, a problem lies in the fact that the released particles gradually form in the cutting area a residual cutting material of plastic material which presses on the different cutting elements until deforming them, and in some cases breaking them.

Blockage in the production line is common in view of this problem. The only solution existing to date is to assign the monitoring of the cutting area to an operator who is responsible for fixing the blockage from time to time; however, this solution is not profitable, so said operator must take care of other jobs, neglecting the monitoring of the cutting device. Therefore, this solution does not solve the problem and blockages happen repeatedly in a continuous manner until the cutting elements deteriorate or break.

### DESCRIPTION OF THE INVENTION

The device for cutting plastic containers object of the invention has technical features aimed at solving the problems set forth above and consisting of the incorporation of means suitable for detecting the accumulation of a specific material thickness in the cutting area and activating an alarm indicating said accumulation of material before the thickness of the accumulated material entails a risk of damage for the cutting device or the blades thereof.

The device for cutting multiple containers proposed by this invention comprises a die and a punch holder, cutting blades for cutting the multi-pack containers arranged in the die and/or the punch holder, wherein said dies and punch holder are arranged facing one another and are enabled to move in an axial direction between an operative cutting position, in which the cutting blades perform a pre-cutting and/or a cutting on individual multi-pack containers placed in between, and an inoperative position in which the die and the punch holder are separated.

In addition, the device for cutting multiple containers includes ejector plates, assembled in the punch holder, and associated with springs, the ejector plates being movable in said axial direction, relative to the punch holder, between a retracted position and an extended position.

In the retracted position, a given thickness of residual cutting material produced during the pre-cutting and/or cutting is accumulated in the cutting area forming a hard mass, the residual cutting material pushing the ejector plate in the axial direction towards the retracted position compressing the referred springs.

In the extended position the springs are in less compressed than in the retracted position or not compressed at all.

The thrust of these springs contributes to the ejection of said residual cutting material moving the ejector plates from the retracted position to the extended position.

According to this invention, each ejector plate also includes a protruding indicator extending away from the ejector plate in the axial direction towards a rear of the punch holder, the protruding indicator typically comprising an end of a rod, said rod being attached to the ejector plate.

The device further comprises one or more position sensors arranged to detect when the protruding indicator reaches a raised position, indicative of the ejector plate reaching a specific retracted position.

The position sensors are configured to determine when said protruding indicator moves beyond a raised position corresponding to a given allowable thickness of residual cutting material of plastic material accumulated in the cutting area.

Said given allowable thickness is quantified such that it is not enough to cause the blockage of the cutting device and the damage or breakage of the blades. Beyond said predetermined allowable thickness, risk of blockage or breakage of the device exists, and cleaning operations are required.

It is worth mentioning that the mentioned sensor can be of any type capable of detecting that at least one of the protruding indicators attached to the ejector plates surpass said raised position of the protruding indicator, corresponding to a predetermined allowable thickness of residual cutting material of plastic material accumulated on the ejector plate in the cutting area, for example: an optical sensor, contact sensor, position sensor, or magnetic sensor capable of detecting a given position of the protruding indicator attached to the ejector plates.

The optical sensor can include, for example, an optical emitter and an optical receiver for a light beam.

Multiple protruding indicators can be simultaneously monitored by a single position sensor, such that one single position sensor can detect when any of multiple ejector plates reach the retracted position.

For example, multiple protruding indicators can be aligned to interrupt the light beam of the optical sensor when reaching the raised position.

According to the invention, the position sensor or sensors is/are connected to a control unit and the position sensor is configured to emit a signal to the control unit when said raised position of a protruding indicator is detected.

The control unit in a preferred embodiment comprises a processor with a memory in which all the incidents (including signals emitted by the position sensors) are recorded, which allows obtaining reports relating to the emitted signals.

The control unit may be connected to an audible alarm and may be configured to activate the audible alarm in response to the signal received from the position sensor.

In this way, the production line operator or manager receives an audible signal indicating that a specific accumulation of residual cutting material has been reached, with said operator being responsible for deciding whether to stop the device in order to remove the accumulated residual cutting material in relation to the ejector plates to avoid running the risk of increasing the accumulation of material and causing the cutting blades to break and new blockages to occur.

The placement of the sensors, both in number and in a particular position, will depend on the nature and amount of containers on which the cutting operation is performed, and on the arrangement of the die and the punch holder.

### BRIEF DESCRIPTION OF THE CONTENTS OF THE DRAWINGS

As a complement to the description provided herein, and for the purpose of helping to make the features of the invention more readily understandable, the present specification is accompanied by a set of drawings which, by way of illustration and not limitation, represent the following:

FIG. 1 shows a front elevational view of an embodiment of a device for cutting plastic containers according to the invention.

FIG. 2 shows an elevational view of the device of the preceding figure, partially disassembled, so as to allow observing an embodiment of the sensor responsible for noticing the accumulation of residual cutting material of plastic material in the cutting area of the containers, by means of a detection of the protruding indicators attached to the ejector plates.

FIG. 3a show respective enlarged details of one of the ejectors plates in the extended position with the protruding indicator (end of rod) in the position (A), including the optical sensor (emitter-receiver) arranged in a rearward region of the punch holder, the light beam emitted by said optical sensor being configured to be interrupted by the protruding indicator when reaching a given raised position.

FIG. 3b shows the same as FIG. 3a but with the protruding indicator of the ejector plate being in a partially retracted position (B), further including an enlarged detail of the end region of the protruding indicator attached to the ejector plate.

FIG. 3c shows a view similar to FIGS. 3a and 3b, with the protruding indicator (end of rod) of the ejector plate in a further retracted position (C) with respect to the position (B) of the protruding indicator of FIG. 3b, due to the accumulation of a specific thickness of residual cutting material of plastic material in the cutting area, said retracted position (C) activating the sensor. This figure also includes an enlarged detail of the position of the rear end of the protruding indicator of the ejector plate.

### DETAILED DESCRIPTION OF EMBODIMENTS OF THE INVENTION

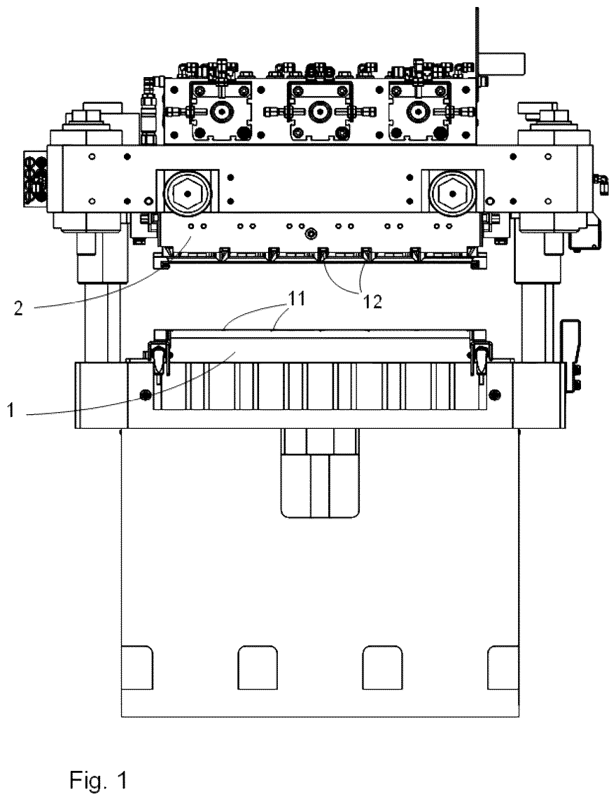

FIG. 1 depicts a device for cutting plastic containers according to the invention, developed for cutting plastic containers made of PET or other materials which release particles in the form of residual cutting material which may accumulate in the cutting area and cause damage to the cutting device. Said device comprises a die 1 and a punch holder 2 vertically movable between an operative cutting position and an inoperative position.

The device comprises cutting blades 11, 21 for cutting plastic containers arranged as know ion the referred state of the art in the die 1 and/or in the punch holder 2.

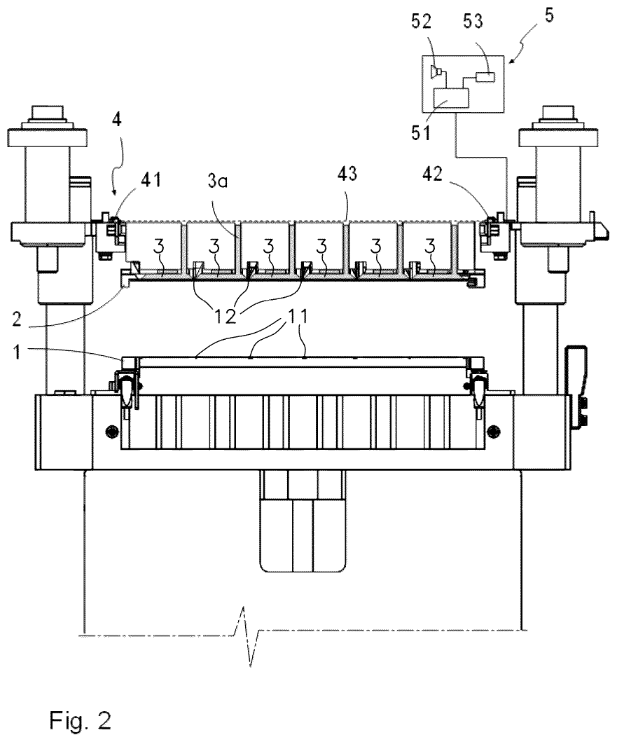

As shown in FIG. 2, the cutting device comprises ejector plates 3 intended for ejecting cut containers, said ejector plates 3 being assembled in the punch holder 2 with the possibility of moving relatively in an axial direction. specifically, in the vertical direction in the figure.

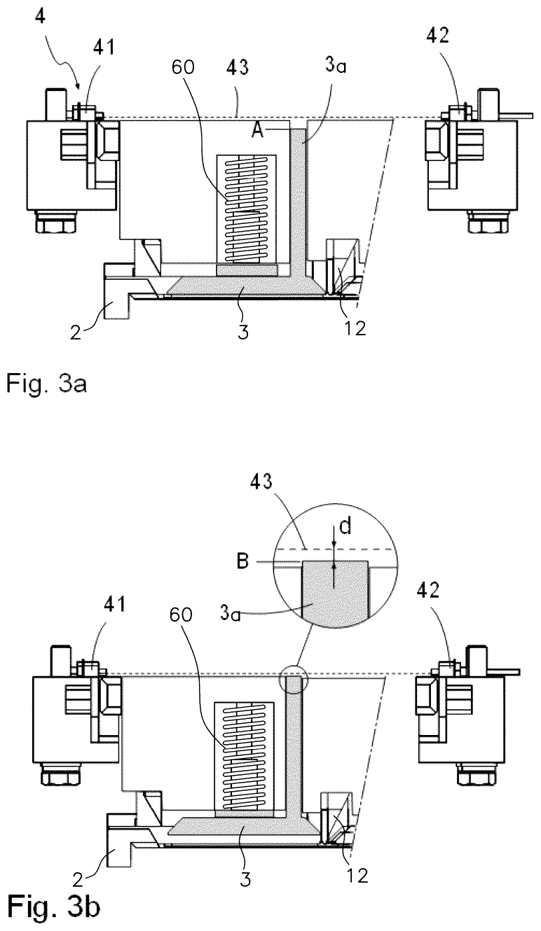

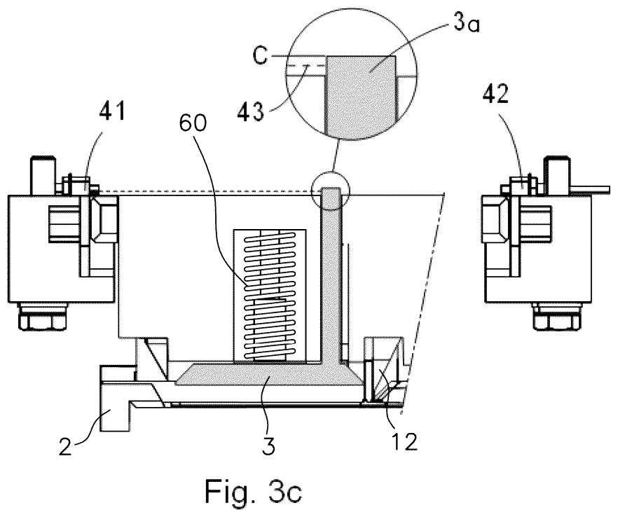

As shown in FIGS. 3 and 3a to 3c, ejector plates 3, assembled in the punch holder 2 are associated with springs 60, the ejector plates 3 being movable in operation in said axial direction, i.e. vertical direction in the figures, between a retracted position in which residual cutting material of plastic material produced during the pre-cutting is accumulated on the cutting area pushing the ejector plates in an axial direction and compressing referred springs 60 and an extended position in which said residual cutting material is ejected by the thrust of these springs 60 on the ejector plate, when these spring 60 are no longer compressed.

In the depictured embodiment springs 60 are arranged around a guiding stem, attached to the rear of ejector plate 3.

According to this invention the ejectors plates 3 have attached thereof protruding indicators that in the disclosed embodiment are in the form of rods 3a, perpendicular to the ejector plates 3.

In operation, ejector plates 3 describe, with respect to the punch holder 2, a nominal stroke of a predetermined length, between an extended position (A) of the protruding indicator (end of rod 3a) and ejector plate 3, depicted in FIG. 3a and a partially retracted position (B) of the protruding indicator in FIG. 3b, when there is only an allowable amount of residual cutting material of plastic material accumulated in the cutting area which corresponds to the pre-cutting of the containers, shown in FIG. 3b.

As shown in FIG. 2, the device further comprises in the punch holder 2 a sensor 4, depicted in this case by an optical sensor with an emitter 41 and a receiver 42, connected to a control unit 5 comprising a processor 51, an audible alarm 52 in a particular embodiment, and a memory 53 for recording incidents.

Said sensor 4 is arranged in a rearward position with respect to the cited position (B) of the protruding indicator (end of the rod 3a) attached to the ejector plates 3 and separated from a further retracted position (C) (FIG. 3c) by a distance (d) equivalent to a predetermined allowable thickness of accumulated material in the cutting area.

In this case, the distance (d) depicted in FIG. 3b is the distance existing between the rear region of the protruding indicator (end of the rods 3a) attached to the ejector plates 3 and the light beam 43 emitted by the optical sensor.

When the residual cutting material of plastic material accumulated in the cutting area exceeds a predetermined allowable thickness, it causes the end of the rod 3a attached to the ejector plate 3 to surpass the cited partially retracted position (B) and reach said further retracted position (C), (FIG. 3c) cutting off the light beam 43 and therefore being detected by the sensor 4.

This detection, caused by the accumulation of residual cutting material of plastic material in the cutting area, causes in the disclosed embodiment the activation of the audible alarm 52 before the occurrence of a blockage which may damage the device or the cutting blades, and the recording of said incident in the memory 53 of the control unit 5; with the line operator or manager being in charge of removing said material to prevent the occurrence of the mentioned blockage or damage in the production line.

Having sufficiently described the nature of the invention, in addition to a preferred exemplary embodiment, it is hereby stated for the relevant purposes that the materials, shape, size and layout of the described elements may be modified, provided that it does not imply altering the essential features of the invention claimed below.

1. A device for cutting plastic containers, comprising:
a die (1) and a punch holder (2) movable in an axial direction between an operative cutting position and an inoperative position;
cutting blades (11, 21) arranged in the die and/or the punch holder; and
multiple ejector plates (3) assembled in the punch holder (2) configured to move, relative to the punch holder (2), in the axial direction and to perform a nominal stroke of a predetermined length between an extended position (A) and retracted position (C) reached by the multiple ejector plates (3) when there is a given thickness of residual cutting material accumulated in a cutting area, each ejector plate (3) being associated to at least one spring (60) configured to be compressed in the axial direction when each ejector plate (3) moves from the extended position (A) to the retracted position (C);
wherein each ejector plate (3) includes a protruding indicator attached to each ejector plate (3), extending away from each ejector plate (3) in the axial direction towards a rear of the punch holder (2); and
wherein the device further comprises at least one position sensor (4) arranged to detect when the protruding indicator reaches a raised position, indicative of each ejector plate (3) reaching the retracted position (C).

2. The device according to claim 1 wherein multiple protruding indicators are simultaneously monitored by a single position sensor (4).

3. The device according to claim 1, wherein said at least one position sensor (4) comprises an optical emitter (41) and an optical receiver (42) for a light beam (43).

4. The device according to claim 1, wherein the at least one position sensor (4) comprises a contact sensor or a magnetic sensor.

5. The device according to claim 1, wherein said protruding indicator comprises a rod (3a) perpendicular to each ejector plate (3).

6. The device according to claim 1, wherein the at least one position sensor (4) is connected to a control unit (5) and is configured to emit a signal to the control unit when said raised position is detected.

7. The device according to claim 6, wherein the control unit (5) comprises a processor (51) and memory (53) for recording the signal emitted by the at least one position sensor (4).

8. The device according to claim 6, wherein the control unit (5) is connected to an audible alarm (52) and is configured to activate the audible alarm (52) in response to the signal received from the at least one position sensor (4).
